(19) United States
(12) Patent Application Publication
(10) Pub. No.: US 2012/0175431 A1
(43) Pub. Date: Jul. 12, 2012

(54) SPRAYING ARM FOR A CLEANING MACHINE FOR CLEANING MEDICAL, PHARMACEUTICAL AND/OR LABORATORY ARTICLES

(76) Inventors: JÜRGEN ALTHAMMER, Kraiburg a. Inn (DE); Helmut FROMBERGER, Waldkraiburg (DE)

(21) Appl. No.: 13/295,195

(22) Filed: Nov. 14, 2011

(30) Foreign Application Priority Data
Nov. 12, 2010 (DE) 102010051218.4-23

(51) Int. Cl. B05B 3/04

(52) U.S. Cl. 239/263

(57) ABSTRACT

A spraying arm for a cleaning machine for cleaning medical, pharmaceutical, and/or laboratory utensils is divided into two half-arms by a rotary coupling supplying spraying agent to and rotationally supporting the spraying arm around a vertical rotational axis. First outlet nozzles in the two half-arms are oriented to produce first spraying-liquid jets in such a way that, when looked at from one end of the spraying arm, all of the jets in the two half-arms are aimed in the same direction. Horizontally oriented second outlet nozzles are arranged at the free ends of the spraying half-arms in such a way that, when looked at from one end of the spraying arm, the second spraying-liquid jets emerging essentially horizontally from the two half-arms proceed in opposite directions for driving the spraying arm around the rotational axis of the rotary coupling.

The invention pertains to a spraying arm for a cleaning machine for cleaning medical, pharmaceutical, and/or laboratory utensils, wherein the spraying arm is divided into two half-arms 3a, 3b by a rotary coupling for supporting the spraying arm so that it can rotate around an essentially vertical axis and for supplying spraying agent and/or drying air, each half-arm comprising outlet nozzles 31, 61 for producing jets 5a, 5b, 6 of spraying liquid aimed in a predetermined jet direction.

Cleaning machines like dishwashers or machines for cleaning medical, pharmaceutical, and/or laboratory utensils comprising a spraying compartment, into which a trolley for holding the objects to be cleaned can be introduced, are known, wherein the term “cleaning” is intended to include the treatment of the individual utensils or objects with a fluid medium such as a spraying liquid, a spray liquid, and/or drying air. These trolleys which hold the objects to be cleaned comprise at least one rotating spraying arm, which can rotate around a vertical axis, which simultaneously forms a rotary coupling, which can supply fluid medium by way of channels, which, when the wheeled trolley is introduced into the spraying compartment, become connected to a supply device arranged in the compartment.

Each of these spraying arms comprises outlet nozzles for producing jets of spraying liquid aimed in a predetermined jet direction, which is at an angle of more than 0° and less than 90° to the rotational axis of the rotary coupling. The spraying arms are driven around their rotational axis by the force of the appropriately aimed jets of fluid medium emerging from the spraying arms.

The invention is based on the goal of creating a spraying arm of the type described above which results in an a significant improvement in the cleaning action.

This goal is achieved by the features given in claim 1.

Advantageous embodiments and elaborations of the invention can be derived from the subclaims.

Because the first outlet nozzles in the two half-arms of the spraying arm for producing first spraying-liquid jets are aimed in such a way that, when looked at from one end of the spraying arm 3, the jets in both half-arms 3a, 3b proceed in the same direction, what happens when the spraying arm rotates is that the items to be washed are treated alternately by a first set of jets slanting in one direction and then by a second set of jets slanting in the opposite direction, so that even difficult to reach areas of the items to be washed are reliably treated by the fluid medium.

The spraying arms can be installed rotatably in the spraying compartment of the cleaning machine and/or on a trolley for the objects to be washed, which can be introduced into the spraying compartment.

At the free ends of the spraying half-arms, horizontally-aimed second outlet nozzles are arranged in such a way that, when looked at from one end of the spraying arm, the second spraying-liquid jets emerging essentially horizontally from the two half-arms proceed in opposite directions, which has the effect of driving the spraying arm around the rotational axis of the rotary coupling.

According to an advantageous embodiment of the invention, the spraying arms 3 comprise an essentially circular cross section, and the first nozzles are formed by outlet bores, which are arranged along a line parallel to a longitudinal axis of the spraying arm on a radius which has an angle of more than 0° and less than 90° to a radius parallel to the rotational axis of the spraying arm. This makes it very easy to produce the spraying arms by drilling holes in standard components such as tubes with the use of an appropriate drilling template.

The free ends of the two spraying half-arms can be sealed off by end caps, wherein third outlet nozzles can be arranged in the end caps in such a way that third spraying-liquid jets proceeding in the longitudinal direction of the spraying arms can be produced to clean the spraying compartment.

Holders for at least one magnet can also be arranged on the end caps in such a way that the at least one magnet is axially offset from the longitudinal axis of the spraying half-arms, wherein the magnets cooperate with stationary magnetic sensors to monitor the rotation of the spraying arm.

The at least one spraying arm can also be part of a spraying arm arrangement, which comprises several spraying arms mounted on a vertical support post, each spraying arm being in fluid-flow connection with the support post, wherein the rotary coupling is mounted on the lower and/or upper end of the support post. In this case, if desired, only some of the spraying half-arms can be equipped with the second outlet nozzles for driving the spraying arm around the rotational axis of the rotary coupling.

Although a vertical axis of rotation of the spraying arms was described above, it would also be possible to apply the same principles to a spraying arm with a horizontal axis of rotation on a wall of the spraying chamber, for example.

The invention is explained in greater detail below on the basis of the exemplary embodiments illustrated in the drawings:

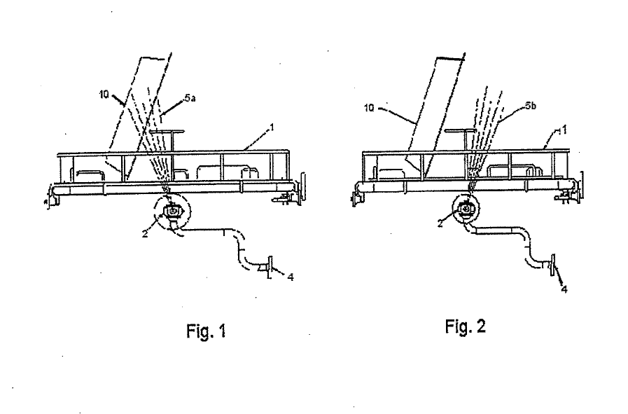

FIG. 1 explains the invention by showing a perspective schematic diagram of a trolley of a cleaning machine equipped with an embodiment of the spraying arm in a first rotational position;

FIG. 2 shows a diagram similar to FIG. 1, in which the spraying arm has been rotated 180°;

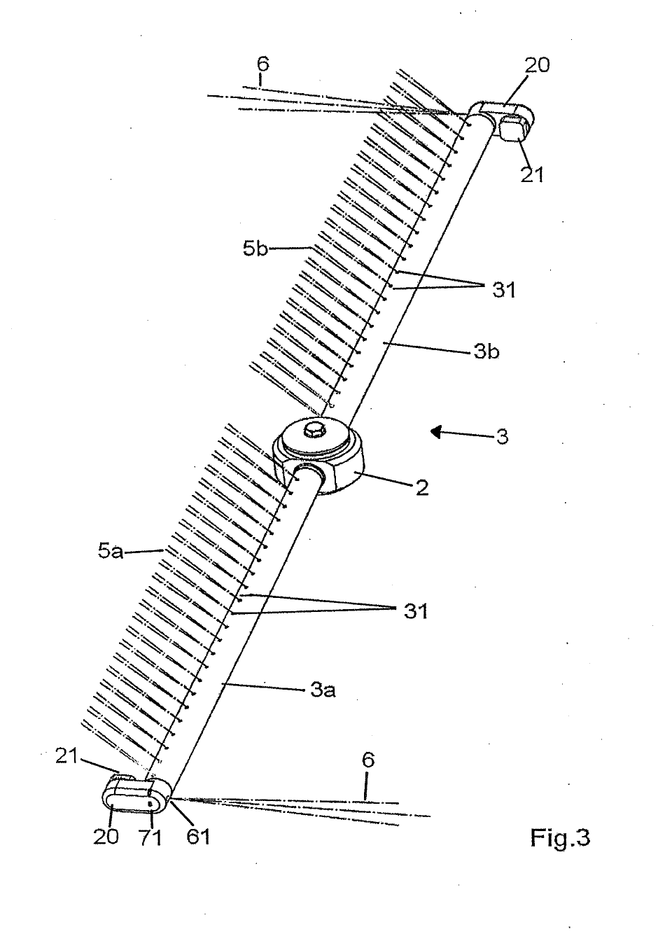

FIG. 3 shows a simplified view of an embodiment of the spraying arm in a first rotational position; and

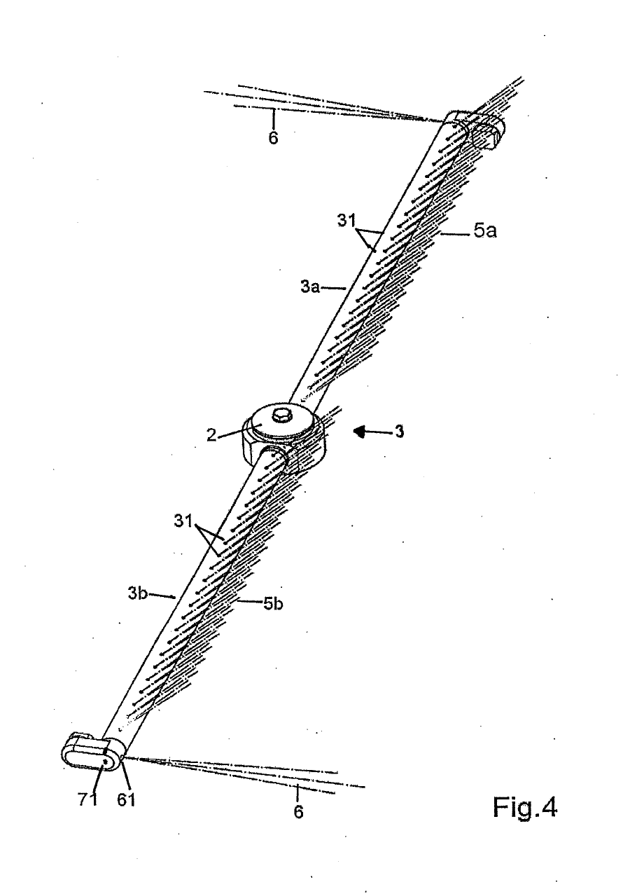

FIG. 4 shows a view of the embodiment of the spraying arm according to FIG. 3 after it has been rotated 180°.

FIGS. 1 and 2 show schematic diagrams of a trolley 1 for the objects to be cleaned, which can be introduced or pushed into a receiving compartment of a cleaning and/or disinfecting and/or drying machine (“cleaning machine” below) for the treatment of medical, pharmaceutical, and/or laboratory utensils. This trolley 1 for objects to be cleaned comprises support surfaces either for baskets to hold the objects to be cleaned or for the objects to be cleaned themselves, which are shown merely in schematic fashion in the form of a tray 10.

Under the trolley 1 is a spraying arm 3, shown in greater detail in FIGS. 3 and 4, which is mounted rotatably by the use of a rotary coupling 2, which is connected to supply devices 4, also shown only schematically, for supplying both spraying and rinsing liquid and also drying air to the spraying arm.

Although only one spraying warm under one level or shelf of the trolley is shown in FIGS. 1 and 2, it is obvious that spraying arms could also be arranged under and/or over this level or shelf or under and/or over all of the levels of a trolley comprising one or more levels.

As can be seen in FIGS. 1-4, the spraying arm 3 is divided by the rotary coupling 2 into two half-arms 3a, 3b, each of which comprises first outlet nozzles 31 for producing spraying-liquid jets 5a, 5b, 6, which proceed in a predetermined direction at an angle of more than 0° and less than 90° to the rotational axis of the rotary coupling, wherein the first outlet nozzles 31 in the two half-arms 3a, 3b of the spraying arm 3 for producing the first spraying-liquid jets are aimed in such a way that the jet directions, when looked at from one end of the spraying arm 3 (i.e., into the plane of the drawing according to FIGS. 1 and 2), are oriented in the same direction in both half-arms 3a, 3b.

This contrasts with the design of conventional spraying arms, in which the jets in the two half-arms slant in opposite directions in order to cause the spraying arm to rotate.

The inventive orientation of the jet directions ensures that, at least during each half-revolution of the spraying arm, otherwise difficult-to-access areas of the items to be washed will be reliably treated with the fluid medium even though the fluid medium jets are directed at a slant.

This is especially easy to see upon comparison of FIG. 1 with FIG. 2, each of which shows the jets of the half-arm of the spraying arm 3 which points outward from the plane of the drawing. FIG. 1 corresponds to the rotational position of the spraying arm 3 shown in FIG. 3, whereas FIG. 2 corresponds to the rotational position of the spraying arm shown in FIG. 4.

When, as in the case of conventional spraying arms, the jets of the spraying half-arms are aimed in opposite directions (that is, if the jets of the half-arm 3a in FIG. 3 were aiming toward the right in the drawing), they would never reach the interior of the tray 10 shown by way of example in FIGS. 1 and 2.

To ensure the drive of the spraying arm 3 even though the first jets 5a, 5b of the spraying half-arms 3a, 3b are aimed in the same direction, horizontally oriented second outlet nozzles 61 are arranged at the free ends of the half-arms 3a, 3b in such a way that, when looked at from one end of the spraying arm 3, the second spraying-liquid jets 6 emerging essentially horizontally from them in the two half-arms 3a, 3b proceed in opposite directions, which has the effect of driving the spraying arm 3 around the rotational axis of the rotary coupling 2.

In the embodiment according to FIGS. 3 and 4, the spraying arms 3 comprise an essentially round cross section, and the nozzles producing the first jets 5a, 5b are formed by outlet holes 31, which are arranged in a line parallel to a longitudinal axis of the spraying arm 3 on a radius which is at an angle of more than 0° and less than 90° to a radius parallel to the rotational axis of the spraying arm 3. This makes it very easy to fabricate the device out of standard components.

The spraying arm could, however, comprise a different cross section and/or have individual nozzles, inserted into the outlet holes 31.

In the exemplary embodiment according to FIGS. 3 and 4, the free ends of the spraying half-arms 3a, 3b are sealed off by end caps 7, in which, in addition to the horizontally oriented second outlet openings or nozzles 61, third outlet openings or nozzles 71 are arranged in such a way that third spraying-liquid jets oriented in the longitudinal direction of the spraying arms 3 are produced.

Holders 20 for at least one magnet 21 can also be arranged on the end caps 7 in such a way that the at least one magnet 21 is axially offset from the longitudinal axis of the spraying half-arms 3a, 3b, wherein the magnets cooperate with stationary magnetic sensors to monitor the rotation of the spraying arm 3.

Although one spraying arm 3 with one rotary coupling 2 assigned to it is shown in FIGS. 3 and 4, this spraying arm 3 with the previously described arrangement of first outlets 31 can also be part of a spraying arm assembly comprising several spraying arms 3, i.e., their two oppositely-directed half-arms 3a, 3b, each arm being attached to a vertical support post, with which it is also in fluid-flow connection, wherein the rotary coupling is mounted at the lower and/or upper end of the support post.

Using a single, common support post both to support the spraying arms and to supply them with fluid medium on the individual levels or shelves of a trolley 1 greatly simplifies the design of the trolley 1, because separate bearings for the spraying arms do not have to be provided on each individual shelf or level, nor do supply connections for the fluid medium have to be provided on each of these spraying arms.

Because only the upper and a lower ends of the support post must be provided with bearings, the friction of the overall spraying arm assembly is also reduced, which means that these spraying arms can rotate more easily at a given pressure of the fluid medium. The essentially horizontally oriented outlets 61 on each of the spraying arms all contribute to the drive of the spraying arm assembly.

1. A spraying arm for a cleaning machine for cleaning medical, pharmaceutical, and/or laboratory utensils, wherein the spraying arm is divided into two half-arms by a rotary coupling for rotationally supporting the spraying arm around an essentially vertical rotational axis and for supplying spraying agent and/or drying air, each half-arm comprising outlet nozzles for producing jets of spraying liquid with a predetermined jet direction, which is at an angle of more than 0° and less than 90° to the rotational axis of the rotary coupling, wherein
first outlet nozzles in the two half-arms of the spraying arm for producing first spraying-liquid jets are oriented in such a way that, when looked at from one end of the spraying arm, the jets in the two half-arms are all aimed in the same direction; and in that
at the free ends of each of the spraying half-arms, horizontally-oriented second outlet nozzles are arranged in such a way that, when looked at from one end of the spraying arm second spraying-liquid jets emerging essentially horizontally from the nozzles in the two half-arms proceed in opposite directions, which has the effect of driving the spraying arm around the rotational axis of the rotary coupling.

2. A spraying arm according to claim 1, wherein the spraying arms are mounted rotatably in a spraying compartment of the cleaning machine and/or on a trolley for the objects to be washed, which can be introduced into the spraying compartment.

3. A spraying arm according to claim 1, wherein the spraying arms comprise an essentially circular cross section, and in that the first nozzles (31) are formed by outlet holes, which are oriented along a line parallel to the longitudinal axis of the spraying arm on a radius at an angle of more than 0° and less than 90° to a radius parallel to the rotational axis of the spraying arm.

4. A spraying arm according to claim 1, wherein the free ends of the spraying half-arms are sealed off by end caps.

5. A spraying arm according to claim 4, wherein outlet nozzles are arranged in the end caps in such a way that third spraying-liquid jets oriented in the longitudinal direction of the spraying arms are produced.

6. A spraying arm according to claim 4, wherein holders for at least one magnet are mounted on the end caps in such a way that the at least one magnet is axially offset from the longitudinal axis of the spraying half-arms, and in that the magnets cooperate with stationary magnetic sensors to monitor the rotation of the spraying arm.

7. A spraying arm according to one of the preceding claims, wherein the spraying arm is part of a spraying arm assembly comprising several spraying arms attached to a vertical support post, these arms being in fluid-flow connection with the support post, wherein the rotary coupling is mounted at the lower and/or upper end of the support post.
